(19) United States
(12) Patent Application Publication
(10) Pub. No.: US 2018/0024939 A1
(43) Pub. Date: Jan. 25, 2018

(54) METHOD FOR EXECUTING A REQUEST TO EXCHANGE DATA BETWEEN FIRST AND SECOND DISJOINT PHYSICAL ADDRESSING SPACES OF CHIP OR CARD CIRCUIT

(71) Applicant: Commissariat a l'energie atomique et aux energies alternatives, Paris (FR)

(72) Inventors: Remy GAUGUEY, Saint Martin d'Uriage (FR); Denis DUTOIT, Fontanil-Cornillon (FR); Eric GUTHMULLER, Ruy (FR); Jerome MARTIN, Meylan (FR)

(73) Assignee: Commissariat a l'energie atomique et aux energies alternatives, Paris (FR)

(21) Appl. No.: 15/548,797

(22) PCT Filed: Feb. 4, 2016
(86) PCT No.: PCT/FR2016/050236

§ 371 Date: Aug. 4, 2017

(30) Foreign Application Priority Data
Feb. 9, 2015 (FR) 1551012

(51) Int. Cl. G06F 12/109

(52) U.S. Cl. CPC G06F 12/109; G06F 2212/1016; G06F 2212/657

(57) ABSTRACT

This method for executing a request to exchange data, between first and second disjoint physical addressing spaces controlled by first and second distinct circuits for first and second respective software processes, comprises the creation of a communication channel between these two circuits. It further comprises sending, by the first process, of said request to exchange data, this request designates a virtual address in a virtual addressing space of the second process, and execution of the request to exchange data between the disjoint physical addressing spaces of the two processes, without invoking a processor executing the second process. During creation of the channel, a translation of the virtual addressing space of the second process into its physical addressing space is created and associated with this channel in the second circuit. During execution of the request, data for identification of the channel is added to the virtual address designated in the request.

This invention relates to a method for executing a request to exchange data between first and second disjoint physical addressing spaces respectively controlled by first and second separate chip or card circuits.

Generally, the two circuits can be mounted on various cards or chips, on the same card or on the same chip, even in the same box thanks to using integration technologies of the SiP (“Silicon in Package”) or 3D types.

Generally also, the two circuits are interconnected by fast communication links that allow each one to access the physical addressing space controlled by the other. These links can take the form of an interconnection matrix of a network on a chip, of a transmission bus, of a high-speed Fiber Channel connection with a point-to-point, ring or switched topology, etc.

The technological context wherein such a request to exchange data is led to be executed primarily relates to multiprocessor architectures with interconnected calculation nodes and techniques for grouping computers into server clusters making it possible to meet the increasing needs for computing power. It is as such possible to design computers of the HPC (“High Performance Computing”) type which can integrate up to ten thousand basic microprocessors with very high clock frequencies and low consumption, interconnected together by very high speed links. In these architectures, qualified as “scale-out”, the memory is distributed between the processors into a plurality of high-capacity local memories and data can be constantly exchanged at high speed from one local memory to another according to processing distributed over several processors that are working in parallel. In these architectures also, circuits provided with processors are generally further provided with hardware support for the virtualization of their operating systems with mechanisms for accelerating this virtualization, for direct memory access control with multiple channels using the RDMA (“Remote Direct Memory Access”) programming model and for the translation of virtual addresses into physical addresses.

The aim can be to reach a maximum of Giga Flops (“Floating-point Operations Per Second”) by invoking a maximum of computers and interconnections at the same time.

The aim can also be to respond to a requirement of energy proportionality required by the computing loads produced by the applications of the family of cloud computing processing of which the variability is a major characteristic. As these applications are widely distributed, memory-hungry and hungry in terms of input/output, but in the end rather little in computing properly speaking, “scale-out” architectures, more efficient from an energy standpoint, are better suited to these new families of applications.

In this context, the invention applies more particularly to a method for executing a request to exchange data comprising the following steps:
creation of a communication channel between:
   a first access port of the first circuit, obtained by a first software process that executes in the first circuit that comprises at least one processor for executing this first software process in the first physical addressing space, and
   a second access port of the second circuit, obtained by a second software process that executes in the second circuit that comprises at least one processor for executing this second software process in the second physical addressing space,
sending, by the first software process, of said request to exchange data, wherein this request designates a virtual address in a virtual addressing space of the second software process, and
executing, by managers of the first and second access ports, of the request to exchange data between the disjoint physical addressing spaces of the two software processes, without invoking the processor executing the second software process.

In order to avoid invoking the processors of the circuits, and in particular that of the second circuit, such a method is generally implemented using expensive network adapters and which are not very efficient from an energy standpoint, for example according to the RoCE (“RDMA over Converged Ethemet”) protocol with 10 Gigabit Ethernet technology used to implement the IEEE 802.3 standard at speeds between 1,000 and 10.000 Mbits/s, according to the Infiniband technology, or according to other technologies and protocols. A concrete example of implementation via the MPI (“Message Passing Interface”) standard in RDMA programming on Infiniband is for example described in the article by Liu et al, entitled “High performance RDMA-based MPI implementation over infiniband”, published in the International Journal of Parallel Programming, Special issue I: The 17th Annual International Conference on Supercomputing (ICS'03), volume 32, no. 3, pages 167-198, June 2004. Another example implementing PCI Express adapters and the PCI-SIG protocol is disclosed in European patent application EP 2 680 155 A1. It should be noted that, regardless of the adapters required, they are further able to add latency in the exchanges of data.

It can as such be desired to provide a method for executing a request to exchange data that makes it possible to overcome at least part of aforementioned problems and constraints.

A method is therefore proposed for executing a request to exchange data between first and second disjoint physical addressing spaces respectively controlled by first and second separate chip or card circuits, comprising the following steps:
creation of a communication channel between:
   a first access port of the first circuit, obtained by a first software process that executes in the first circuit that comprises at least one processor for executing this first software process in the first physical addressing space, and
   a second access port of the second circuit, obtained by a second software process that executes in the second circuit that comprises at least one processor for executing this second software process in the second physical addressing space,
sending, by the first software process, of said request to exchange data, wherein this request designates a virtual address in a virtual addressing space of the second software process, and
executing, by managers of the first and second access ports, of the request to exchange data between the disjoint physical addressing spaces of the two software processes, without invoking the processor executing the second software process.
   according to which:
during the creation of the communication channel, a translation of the virtual addressing space of the second software process into its physical addressing space is created and associated to this communication channel in the second circuit, and
during the execution of the request, data for identification of the communication channel is added to the virtual address designated in the request.

As such, through an inexpensive cunning and without any substantial increase in energy costs, i.e. the adding a few bits to the virtual address designated in the request in order to insert therein data for the identification of the communication channel, it is possible to execute on the side of the second circuit a fast and easy translation of this virtual address into a physical address of the physical addressing space controlled by the second circuit, without invoking its processor and without any need in terms of network adaptation.

Optionally, the translation of the virtual addressing space of the second software process into its physical addressing space is used by a memory management unit of the second circuit in order to determine which physical address of the second physical addressing space corresponds to the virtual address designated in the request using data for the identification of the communication channel added to this virtual address.

Optionally also, the data for the identification of the communication channel added to the virtual address designated in the request comprises an identifier of the second circuit, of an operating system whereon the second software process is executed and of the second access port obtained by the second software process, and an identifier of an exchange buffer memory defined on the side of the second circuit.

Optionally also, the data for the identification of the communication channel is added to the virtual address designated in the request by the manager of the first access port of the first circuit.

Optionally also, the adding of data for the identification of the communication channel to the virtual address designated in the request is carried out through encapsulation of this virtual address in a transport address, with this transport address being sent then processed by the manager of the second access port as a virtual address to be translated.

Optionally also, the execution of the request is managed by direct communication established between the processor of the first circuit and a local memory of the second circuit.

In this case, optionally:
the translation of the virtual addressing space of the first software process into its physical addressing space is used by a memory management unit of the processor of the first circuit, and
this memory management unit further makes use of the translation of the virtual addressing space of the second software process into a temporary physical addressing space used to index a look-up table wherein the data for the identification of the communication channel is stored.

Optionally also, the execution of the request is managed by an indirect communication established between the processor of the first circuit and a local memory of the second circuit with the invoking of a direct memory access controller for read and write access, in local memory or remotely, independent of the processor of the first circuit.

In this case, optionally:
the translation of the virtual addressing space of the first software process into its physical addressing space is used by a memory management unit associated specifically to the direct memory access controller, and
this memory management unit further makes use of the translation of the virtual addressing space of the second software process into a temporary physical addressing space used to index a look-up table wherein the data for the identification of the communication channel is stored.

Optionally also, the request to exchange data sent by the first software process concerns:
a reading of the data stored in the first physical addressing space wherein the first software process is executed and a writing of this data in the second physical addressing space wherein the second software process is executed, or
a reading of the data stored in the second physical addressing space wherein the second software process is executed and a writing of this data in the first physical addressing space wherein the first software process is executed.

Optionally also, at least one of the first and second software processes is executed on a virtual machine which is itself executed by a hypervisor of the corresponding processor, with each translation of a virtual address into a corresponding local physical address comprising a translation of the virtual address into an intermediate physical address as viewed by the virtual machine and a translation of the intermediate physical address into a physical address as seen by the hypervisor.

The invention shall be better understood using the following description, provided solely as an example and given in reference to the annexed drawings wherein:

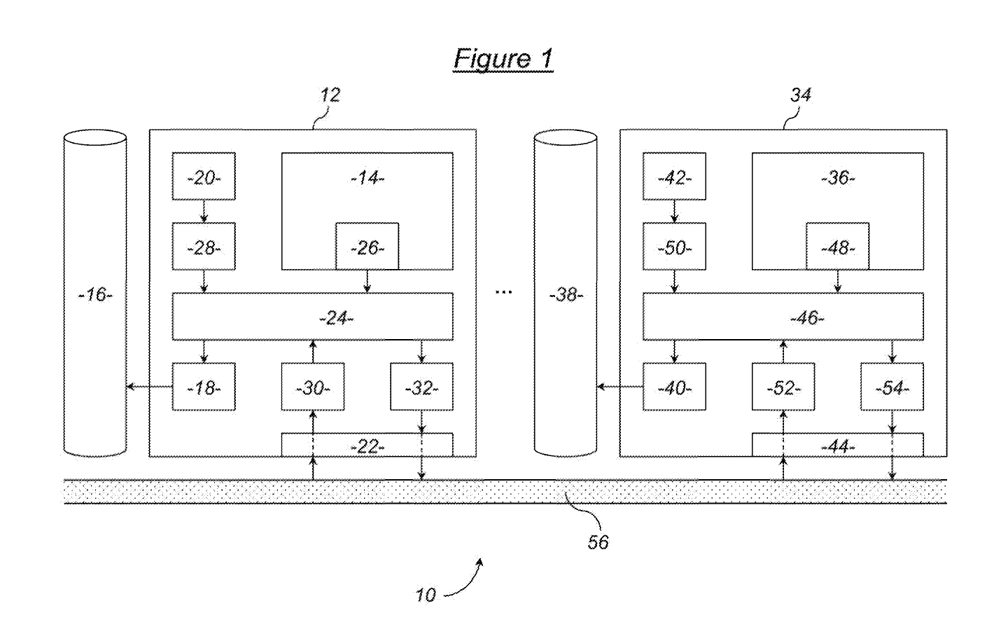

FIG. 1 diagrammatically shows the general structure of a system on a card or chip adapted for the implementation of a method for executing a request to exchange data according to the invention,

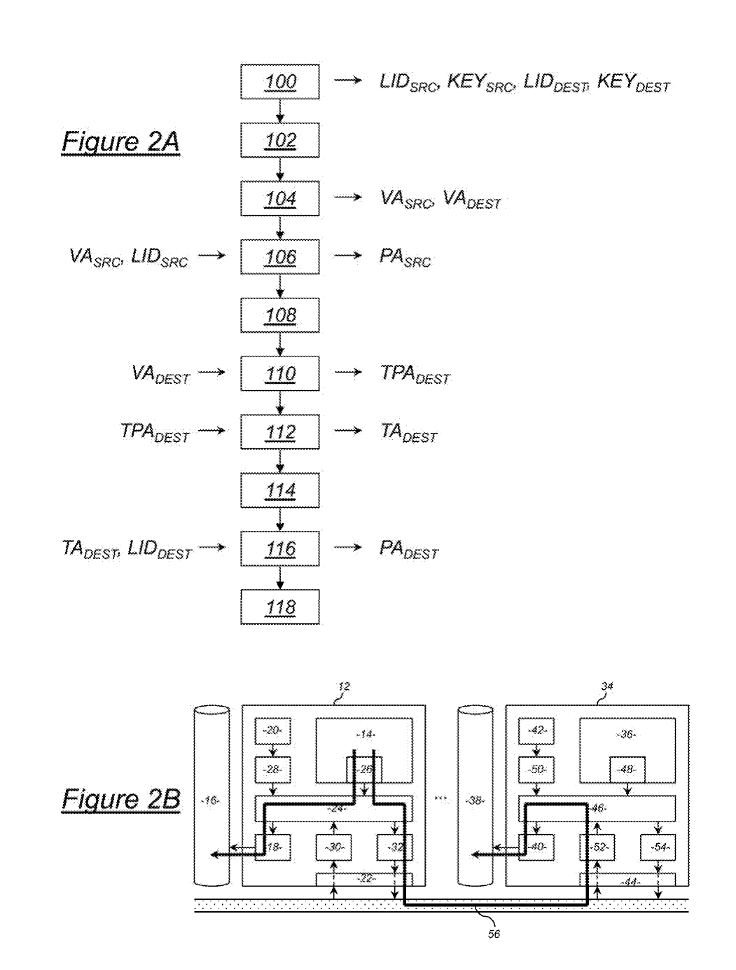

FIGS. 2A and 2B show the successive steps of a method for executing a request to exchange data between two circuits of the system of FIG. 1 as well as the corresponding read/write paths, according to a first embodiment of the invention, and

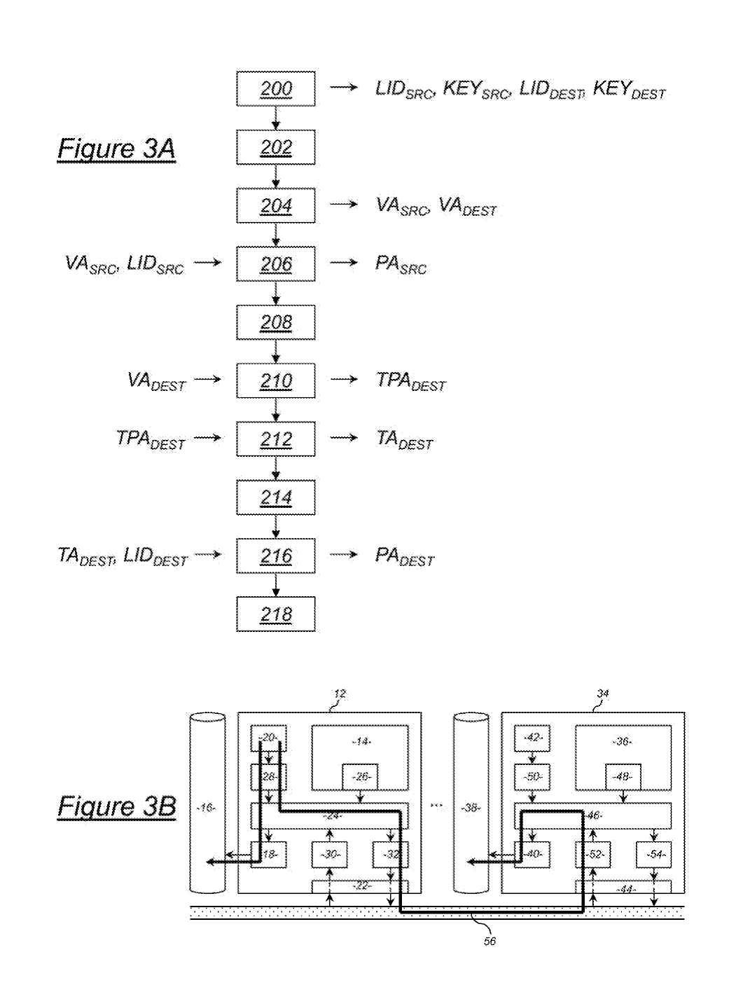

FIGS. 3A and 3B show the successive steps of a method for executing a request to exchange data between two circuits of the system of FIG. 1 as well as the corresponding read/write paths, according to other embodiments of the invention.

The system 10, on a card or chip, diagrammatically shown in FIG. 1, comprises a plurality of circuits of which only two are shown.

A first circuit 12 comprises a main processor 14, of the mono- or multi-processor, mono- or multi-core type. It is moreover associated with a local memory 16 and comprises, for read or write access therein, a memory controller 18. It further comprises a coprocessor 20 for direct memory access, more precisely a DMA (“Direct Memory Access”) controller. Direct memory access is a well-known computing method according to which data coming from or intended to be sent to a peripheral device, for example another circuit of the system 10, is transferred directly by the DMA controller 20 to or from the local memory 16, without intervention of the main processor 14 except for launching and concluding the transfer. The first circuit 12 further has an interface 22 for connecting to the rest of the system 10. The main processor 14, the memory controller 18, the DMA controller 20 and the interface 22 are interconnected in the first circuit 12 using an internal interconnection network 24.

The main processor 14 is intended to execute instructions of software processes in physical addressing spaces which are reserved for them in local memory 16. It can do this by the intermediary of an operating system that is proper to it or by the intermediary of one or more guest operating systems, qualified as “virtual machines”, which are themselves executed by a hypervisor or VMM (“Virtual Machine Monitor”). In any case, the memory addresses identified in the instructions of the software processes are virtual and have to be translated into physical addresses in the corresponding physical addressing spaces for good execution of these instructions. That is why the main processor 14 comprises a memory management unit 26, called MMU (“Memory Management Unit”), of which the function is to carry out these translations of virtual addresses into physical addresses for each software process. When a software process is executed directly on the operating system of the main processor 14, a single level of translation of a virtual address into a physical address is carried out by the MMU 26. On the other hand, when a software process is executed on a virtual machine of the main processor 14, two levels of translation of a virtual address into an intermediate physical address (the one viewed by the virtual machine), then of the intermediate physical address into a physical address (that as viewed by the hypervisor), are carried out by the MMU 26.

With regards to the DMA controller 20 of which the read and write access to the local memory 16 are independent of the main processor 14, it also manages virtual addresses of process Instructions, in such a way that it also needs a memory management unit 28 independent of the MMU 26. This memory management unit 28 specific to the DMA controller 20 is generally called IOMMU (“Input/Output Memory Management Unit”) because it concerns input/output of the first circuit 12. It has one or two levels of translation.

Moreover, as shall be seen in what follows for the implementing of a data exchange according to the invention, the first circuit 12 comprises an additional memory management unit 30, independent of the MMU 26 and of the IOMMU 28, for translating into physical addresses of the local memory 16, virtual addresses included in requests to exchange data received by the first circuit 12 via the interface 22. This additional memory management unit 30 is also generally called IOMMU because it also concerns input/output of the first circuit 12. It also has one or two levels of translation.

Finally, as shall be seen also in what follows for the implementing of a data exchange according to the invention, the first circuit 12 comprises means for putting virtual addresses into correspondence with identification data of the communication channels established between software processes of the first circuit 12 and software processes of other circuits. These means take for example the form of a correspondence table 32, generally called an LUT (“Look-Up Table”), used to add communication channel identification data in requests to exchange data sent by the first circuit 12 via the interface 22.

A second circuit 34 shown in FIG. 1 is identical to the first circuit 12. It comprises a main processor 36, is associated with a local memory 38 and comprises, for read or write access therein, a memory controller 40. It further has a DMA controller 42 and an interface 44 for connecting to the rest of the system 10. The main processor 36, the memory controller 40, the DMA controller 42 and the interface 44 are interconnected in the second circuit 34 using an internal interconnection network 46.

The main processor 36 comprises an MMU 48 of which the function is to carry out translations of virtual addresses into physical addresses for each software process that it executes. As with the first circuit 12, when a software process is executed directly on the operating system of the main processor 36, a single level of translation of a virtual address into a physical address is carried out by the MMU 48. On the other hand, when a software process is executed on a virtual machine of the main processor 36, two levels of translation of a virtual address into an intermediate physical address (the one viewed by the virtual machine), then of the intermediate physical address into a physical address (that as viewed by the hypervisor), are carried out by the MMU 48.

With regards to the DMA controller 42 of which the read and write access to the local memory 38 are independent of the main processor 36, it also manages virtual addresses of process instructions, so that it is associated with an IOMMU 50 with one or two levels of translation.

Moreover, by symmetry with the first circuit 12, the second circuit 34 comprises an additional IOMMU 52 with one or two levels of translation, independent of the MMU 48 and of the IOMMU 50, for translating into physical addresses of the local memory 38, virtual addresses included in requests to exchange data received by the second circuit 34 via the interface 44.

Finally, also by symmetry with the first circuit 12, the second circuit 34 comprises means for putting virtual addresses into correspondence with identification data of the communication channels established between software processes of the second circuit 34 and software processes of other circuits. These means take for example the form of a LUT 54, used to add communication channel identification data in requests to exchange data sent by the second circuit 34 via the interface 44.

The first and second circuits 12 and 34 are connected to each other using an interconnection 56 that can take the form of an interconnection matrix of a network on a chip, of a transmission bus, of a high-speed Fiber Channel connection with a point-to-point, ring or switched topology, etc.

A method for executing a request to exchange data between disjoint physical addressing spaces respectively controlled by the first and second circuits 12 and 34 shall now be described in detail in reference to FIGS. 2A, 2B and 3A, 38 according to various possible embodiments. In these figures and by way of a non-limiting example, the request is sent by a first software process that executes in the first circuit 12, with a first physical addressing space being allocated to this first software process in the local memory 16 by the main processor 14. It relates to an exchange of data with a second physical addressing space, disjoint from the first, allocated in the local memory 38 by the main processor 36 to a second software process executing in the second circuit 34.

In accordance with a first embodiment of the invention, FIG. 2A shows the implementation of such a method in the following context:
a direct communication, i.e. without invoking the controller DMA 20 and its IOMMU 28, can be established between the main processor 14 of the first circuit 12 and the local memory 38 of the second circuit 34,
the virtual addresses are coded over 64 bits and the physical addresses over 48 bits,
the first software process that is sending the request to exchange data is executed directly on the operating system of the main processor 14, and
The required data exchange is a remote write, i.e. a reading of the data stored in the first physical addressing space of the memory 16 wherein the first software process is executed and a writing of this data in the second physical addressing space of the memory 38 wherein the second software process is executed.

In this embodiment, the presence of the controller DMA 20 and of its IOMMU 28 is not necessary. By symmetry, the presence of the controller DMA 42 and of its IOMMU 50 also is not necessary.

During a first step of negotiation 100 of a phase of creating a communication channel, a communication channel is negotiated between a first access port of the first circuit 12, obtained by the first software process that executes in the first circuit 12, and a second access port of the second circuit 34, obtained by the second software process executing in the second circuit 34. In accordance with this transaction established between the two software processes of which the physical addressing spaces are concerned by the exchange, an exchange memory buffer is allocated by the operating system of the main processor 14, with this buffer memory defining a first virtual addressing space to be used for the first software process and a second virtual addressing space to be used for the second software process in the first circuit 12. Likewise via reciprocity, an exchange buffer memory is also allocated by the operating system of the main processor 36 on the side of the second circuit 34. Using by way of a non-limiting example a semantic of the Infiniband type, the communication channel can be entirely identified by the following data quadruplet:
LID_{SRC}: a parameter, for example coded over 16 bits, that identifies the first circuit 12, the operating system whereon the first software process is executed in the first circuit 12 and the first access port of the first circuit 12,
KEY_{SRC}: a parameter, for example coded over 16 bits, which securely identifies the exchange buffer memory defined on the side of the first circuit 12,
LID_{DEST}: a parameter, for example coded over 16 bits, that identifies the second circuit 34, the operating system whereon the second software process is executed in the second circuit 34 and the second access port of the second circuit 34,
KEY_{DEST}: a parameter, for example coded over 16 bits, which securely identifies the exchange buffer memory defined on the side of the second circuit 34.

This quadruplet (LID_{SRC}, KEY_{SRC}, LID_{DEST}, KEY_{DEST}) uniquely defines the transaction established between the two software processes concerned by the data exchange.

More precisely, the pair (LID_{SRC}, KEY_{SRC}) defines the memory context to be used possibly on the side of the first circuit 12 in order to carry out the translations between virtual addresses and physical addresses and the pair (LID_{DEST}, KEY_{DEST}) defines the memory context to be used on the side of the second circuit 34 in order to carry out the translations between virtual addresses and physical addresses. The four parameters are filled in during the first step 100 and stored in memory by the two circuits 12 and 34. Note that the protocol implemented for the negotiation of this quadruplet of parameters is independent of this invention and can be chosen freely from protocols that are well known to those skilled in the art.

During a following step of configuring 102 the creation phase of the communication channel, the MMU 26 of the main processor 14 of the first circuit 12 is configured to carry out a translation of the virtual addressing space of the first software process into its physical addressing space. This can be done in association with the communication channel negotiated, i.e. in association with the memory context (LID_{SRC}, KEY_{SRC}), but in direct communication between the main processor 14 of the first circuit 12 and the local memory 38 of the second circuit 34 this can also be done in another way, in a way known per se, without needing this memory context. Likewise, the IOMMU 52 of the second circuit 34 is configured to carry out a translation of the virtual addressing space of the second software process into its physical addressing space in association with the communication channel negotiated, i.e. In association with the memory context (LID_{DEST}, KEY_{DEST}). Furthermore, the MMU 26 of the main processor 14 of the first circuit 12 is configured to carry out a translation of the virtual addressing space of the second software process into a temporary physical addressing space, representing the physical addressing space of the second software process as viewed from the first circuit 12. Finally, the LUT 32 of the first circuit 12 is configured to associate this temporary physical addressing space to the memory context (LID_{DEST}, KEY_{DEST}) that can be used by the second circuit 34.

Then, during a step 104, the first software process sends a remote write request, with this request designating a first virtual address VA_{SRC} of data to be read in the first virtual addressing space of the first software process and a second virtual address VA_{DEST} wherein to write the data read, with this second virtual address VA_{DEST} being included in the second virtual addressing space of the second software process.

These two virtual addresses VA_{SRC} and VA_{DEST} are coded over 64 bits.

During a following step 106, the virtual address VA_{SRC} is translated by the MMU 26 into a 48-bit physical address PA_{SRC}. This physical address PA_{SRC} precisely locates the data to be read in the local memory 16, in the physical addressing space allocated to the first software process by the main processor 14.

Then, during a read step 108, the data to be read in the local memory 16 is read.

During a following step 110, the virtual address VA_{DEST} is translated by the MMU 26 into a temporary physical address TPA_{DEST}. This temporary physical address TPA_{DEST} is coded over 48 bits and does not have any concrete signification. On the other hand, it comprises a translation IOVA_{DEST} of the second virtual address VA_{DEST}, coded over 32 bits and that can be used by the IOMMU 52 of the second circuit 34, a parameter IKEY_{DEST} coded over 12 bits, with this parameter IKEY_{DEST} being derived from the parameter KEY_{DEST} in order to index the LUT 32, a complement at 0 to the 47^{th} bit and a most significant bit at 1. It as such takes for example the following form:

### TPA_{DEST}:

| | | |
|---|---|---|
| 47... 44 | 43 ... 32 | 31 ... 0 |
| 1 0 0 0 | IKEY_{DEST} | IOVA_{DEST} |

The most significant bit at 1 indicates for example that this temporary physical address indexes the LUT 32.

During a following step 112, a manager of the first access port of the first circuit 12 (i.e. the operating system of the main processor 14) recovers, using the LUT 32 indexed by the temporary physical address TPA_{DEST}, in particular by its parameter IKEY_{DEST}, the pair (LID_{DEST}, KEY_{DEST}) identifying the memory context that can be used by the second circuit 34. It makes use of this to add the parameters of this pair to the virtual address IOVA_{DEST} now designated in the remote write request.

By way of a concrete example, the temporary physical address TPA_{DEST} is translated into a transport address TA_{DEST} coded over 64 bits:

### TA_{DEST}:

| | | |
|---|---|---|
| 63 ... 48 | 47 ... 32 | 31 ... 0 |
| 0 ... 0 | KEY_{DEST} | IOVA_{DEST} |

The remote write request is then transmitted by the manager of the first access port of the first circuit 12 to the interconnection 56 via the interface 22 during a transmission step 114. This request comprises the transport address TA_{DEST} accompanied by the parameter LID_{DEST}. It is conventionally routed through the interconnection 56 to the second circuit 34. This routing can be facilitated thanks to specific information contained in the parameter LID_{DEST}.

Upon reception 116 of this request by a manager of the second access port of the second circuit 34 (i.e. the operating system or the hypervisor of the main processor 36), the transport address TA_{DEST} accompanied by the parameter LID_{DEST} is translated by the IOMMU 52 into a physical address PA_{DEST} over 48 bits thanks to the virtual address IOVA_{DEST}, included in the transport address TA_{DEST}, and to at least one portion of the data of the context memory (LID_{DEST}, KEY_{DEST}) of which the parameter KEY_{DEST} is included in the transport address TA_{DEST} and of which the parameter LID_{DEST} accompanies this transport address. The manager of the second access port of the second circuit 34 therefore does not need to invoke the main processor 36 in order to carry out this translation.

Then, during a step of writing 118, the data read in the local memory 16 is written in the local memory 38, at the physical address designated by PA_{DEST}.

The path of the read and write access of the method of FIG. 2A is shown in FIG. 2B. Note that, even if the main processor 14 of the first circuit 12 is invoked for a remote write, this is not the case of the main processor 36 of the second circuit 34. It is further noted that no particular network adapter is invoked.

Note that it is simple to adapt the method described hereinabove to a remote read. It is sufficient to send a read request in the step 104, then to execute steps 110 to 116 instead of step 106, then to replace step 118 with a step 118′ of reading data at the physical address PA_{DEST} of the local memory 38, then of transmitting this data read to the first circuit 12, then to execute the step 106, then finally to replace the step 108 with a step 108′ of writing data to the physical address PA_{SRC} of the local memory 16.

Note also that it is simple to adapt the method described hereinabove for a data exchange of which the request would be sent at the initiative of the second software process of the second circuit 34.

As such, by symmetry, during the step of configuration 102, the MMU 48 of the main processor 36 of the second circuit 34 can be configured to carry out a translation of the virtual addressing space of the second software process into its physical addressing space in association with the communication channel negotiated. i.e. in association with the memory context (LID_{DEST}, KEY_{DEST}). Likewise, the IOMMU of the first circuit 12 can be configured to carry out a translation of the virtual addressing space of the first software process into its physical addressing space in association with the communication channel negotiated, i.e. in association with the memory context (LID_{SRC}, KEY_{SRC}). Furthermore, the MMU 48 of the main processor 36 of the second circuit 34 can be configured to carry out a translation of the virtual addressing space of the second software process into a temporary physical addressing space, representing the physical addressing space of the first software process as viewed from the second circuit 34. Finally, the LUT 54 of the second circuit 34 can be configured to associate this temporary physical addressing space to the memory context (LID_{SRC}, KEY_{SRC}) that can be used by the first circuit 12. It is then sufficient to adapt the steps 104 to 118 for a remote read or write sent from the second circuit 34.

In accordance with a second embodiment of the invention, FIG. 3A shows the implementation of a method for executing a request to exchange data in the following context:
an indirect communication, i.e. with the invoking of the controller DMA 20 and of its IOMMU 28, is established between the main processor 14 of the first circuit 12 and the local memory 38 of the second circuit 34,
the virtual addresses are coded over 64 bits and the physical addresses over 48 bits,
the first software process that is sending the request to exchange data is executed directly on the operating system of the main processor 14, and
the data exchange required is a remote write, i.e. a reading of the data stored in the first physical addressing space of the memory 16 wherein the first software process is executed and a writing of this data in the second physical addressing space of the memory 38 wherein the second software process is executed.

In this embodiment, the presence of the controller DMA 20 and of its IOMMU 28 is necessary. By symmetry, the presence of the controller DMA 42 and of its IOMMU 50 is also necessary if a data exchange is considered of which the request is sent at the initiative of the second software process of the second circuit 34. The communications managed by the DMA controller are carried out according to the RDMA programming model, without it being necessary to provide details on the operation of this well-known model in the rest of the description.

The first step of negotiating 200 of the creation phase of the communication channel of this second embodiment is identical to the step 100 described hereinabove.

During a following step of configuring 202 the creation phase of the communication channel, the IOMMU 28 of the DMA controller 20 of the first circuit 12 is configured to carry out a translation of the virtual addressing space of the first software process into its physical addressing space in association with the communication channel negotiated, i.e. in association with the memory context (LID_{SRC}, KEY_{SRC}). Likewise, the IOMMU 52 of the second circuit 34 is configured to carry out a translation of the virtual addressing space of the second software process into its physical addressing space in association with the communication channel negotiated, i.e. in association with the memory context (LID_{DEST}, KEY_{DEST}). Furthermore, the IOMMU 28 of the DMA controller 20 of the first circuit 12 is configured to carry out a translation of the virtual addressing space of the second software process into a temporary physical addressing space, representing the physical addressing space of the second software process as viewed from the first circuit 12. Finally, the LUT 32 of the first circuit 12 is configured to associate this temporary physical addressing space to the memory context (LID_{DEST}, KEY_{DEST}) that can be used by the second circuit 34.

Then, during a step 204, the first software process sends a remote write request, with this request designating a first virtual address IOVA_{SRC} of data to be read in the first virtual addressing space of the first software process and a second virtual address IOVA_{DEST} wherein to write the data read, with this second virtual address IOVA_{DEST} being included in the second virtual addressing space of the second software process. These two virtual addresses IOVA_{SRC} and IOVA_{DEST}, which can be used by the controller DMA 20 and its IOMMU 28, are handled by the DMA controller 20.

More precisely, the first virtual address IOVA_{SRC}, coded over 32 bits, is encapsulated in a more complete virtual address VA_{SRC} coded over 64 bits which further comprises the parameter KEY_{SRC} coded over 16 bits and a complement at 0:

### VA_{SRC}:

| | | |
|---|---|---|
| 63 ... 48 | 47 ... 32 | 31 ... 0 |
| 0 ... 0 | KEY_{SRC} | IOVA_{SRC} |

More precisely also, the second virtual address IOVA_{DEST}, coded over 32 bits, is encapsulated in a more complete virtual address VA_{DEST} coded over 64 bits which further comprises the parameter IKEY_{DEST} defined hereinabove, and a complement at 0:

### VA_{DEST}:

| | | |
|---|---|---|
| 63 ... 44 | 43 ... 32 | 31 ... 0 |
| 0 ... 0 | IKEY_{DEST} | IOVA_{DEST} |

During a following step 206, the virtual address IOVA_{SRC} is translated by the IOMMU 28 into the physical address PA_{SRC} defined hereinabove thanks to the memory context (LID_{SRC}, KEY_{SRC}) which is known to the DMA controller 20.

Then, during a read step 208, the data to be read in the local memory 16 is read by the DMA controller 20 without invoking the main processor 14.

During a following step 210, the virtual address VA_{DEST} is translated by the IOMMU 28 into the temporary physical address TPA_{DEST} defined hereinabove. The translation consists in this embodiment in simply suppressing the 16 most significant bits of VA_{DEST} and in setting the 48^{th} bit to 1.

The following steps 212 to 218 are identical to the steps 112 to 118 of the preceding embodiment.

The path of the read and write access of the method of FIG. 3A is shown in FIG. 38. Note that none of the main processors 14 and 36 is invoked. It is further noted that no particular network adapter is invoked.

Note that it is simple, as in the first embodiment, to adapt the method described hereinabove to a remote read or for a data exchange of which the request would be sent at the initiative of the second software process of the second circuit 34.

As such, by symmetry, during the step of configuring 202, the IOMMU 50 of the DMA controller 42 of the second circuit 34 can be configured to carry out a translation of the virtual addressing space of the second software process into its physical addressing space in association with the communication channel negotiated, i.e. in association with the memory context (LID_{DEST}, KEY_{DEST}). Likewise, the IOMMU 30 of the first circuit 12 can be configured to carry out a translation of the virtual addressing space of the first software process into its physical addressing space in association with the communication channel negotiated, i.e. in association with the memory context (LID_{SRC}, KEY_{SRC}). Furthermore, the IOMMU 50 of the DMA controller 42 of the second circuit 34 can be configured to carry out a translation of the virtual addressing space of the second software process into a temporary physical addressing space, representing the physical addressing space of the first software process as viewed from the second circuit 34. Finally, the LUT 54 of the second circuit 34 can be configured to associate this temporary physical addressing space to the memory context (LID_{SRC}, KEY_{SRC}) which can be used by the first circuit 12.

A third embodiment of the Invention, also shown by the FIGS. 3A and 3B, differ from the preceding only in that the virtual addresses of the DMA controller 20 are coded over 32 bits (those of the main processor 14 which can be coded over 64 or 32 bits) and the physical addresses over 40 bits.

In this case, during the step 204, the first virtual address IOVA_{SRC} is not coded over 32 bits but over 24 bits only. It is encapsulated in the more complete virtual address VA_{SRC} coded over 32 bits which further comprises a compressed version CKEY_{SRC} the parameter KEY_{SRC}, coded over 8 bits:

### VA_{SRC}:

| | |
|---|---|
| 31 ... 24 | 23 ... 0 |
| CKEY_{SRC} | IOVA_{SRC} |

In this case also, the second virtual address IOVA_{DEST} is also coded over 24 bits. It is encapsulated in the more complete virtual address VA_{DEST} coded over 32 bits which further comprises a compressed version CKEY_{DEST} of the parameter KEY_{DEST}, coded over 8 bits:

### VA_{DEST}:

| | |
|---|---|
| 31 ... 24 | 23 ... 0 |
| CKEY_{DEST} | IOVA_{DEST} |

The step 206 is adapted to recover the parameter KEY_{SRC} using the compressed parameter CKEY_{SRC}, using a conventional cache function, in such a way that the physical address PA_{SRC} coded over 40 bits can be recovered thanks to the memory context (LID_{SRC}, KEY_{SRC}).

In this case also, during the step 210, the virtual address VA_{DEST} coded over 32 bits is translated by the IOMMU 28 into a temporary physical address TPA_{DEST} coded over 40 bits. The translation consists in this embodiment in recovering the parameter IKEY_{DEST} defined hereinabove using the compressed parameter CKEY_{DEST} then in completing the last 4 bits with “1 0 0 0”:

### TPA_{DEST}:

| | | |
|---|---|---|
| 39...36 | 35 ... 24 | 23 ... 0 |
| 1 0 0 0 | IKEY_{DEST} | IOVA_{DEST} |

In this case also, during the step 212, the transport address TA_{DEST}, obtained by translation of the temporary physical address TPA_{DEST} using the LUT 32, is coded over 40 bits:

### TA_{DEST}:

| | |
|---|---|
| 39 ... 24 | 23 ... 0 |
| KEY_{DEST} | IOVA_{DEST} |

In this case also, during the step 216, the address PA_{DEST} obtained by translation of the transport address TA_{DEST} using the IOMMU 52, is coded over 40 bits.

As with the second embodiment, the first embodiment could also be adapted to virtual addresses coded over 32 bits and physical addresses over 40 bits by adapting its steps 100 to 118 in accordance to what was done for the third embodiment. Generally, note that the coding of virtual addresses over 32 or 64 bits is relatively standard, with coding over 64 bits being widespread in the processors. On the other hand, the number of bits over which the physical addresses can be coded is clearly freer. It was chosen, in the preceding embodiments, to code them over 40 or 48 bits but other choices could have been made.

A fourth embodiment of the invention, also shown in FIGS. 3A and 3B, differs from the preceding one only in that the two software processes concerned by the request to exchange data are executed on virtual machines of the main processors 14 and 36.

In this case, the step 206 is adapted to recover the physical address PA_{SRC} in two successive translations carried out by the IOMMU 28. A first translation, carried out on the virtual machine which executes the first software process in the first circuit 12, makes it possible to translate the virtual address VA_{SRC} over 32 bits into an intermediate physical address IPA_{SRC} over 40 bits. A second translation, carried out on the hypervisor which executes this virtual machine, makes it possible to translate the intermediate physical address IPA_{SRC} into the physical address PA_{SRC} coded over 40 bits.

In this case also, the step 210 is adapted to recover the temporary physical address TPA_{DEST} in two successive translations carried out by the IOMMU 28. A first translation, carried out on the virtual machine that executes the first software process in the first circuit 12, makes it possible to translate the virtual address VA_{DEST} over 32 bits into an intermediate temporary physical address ITPA_{DEST} over 40 bits wherein the parameter IKEY_{DEST} was translated into a virtualized parameter VIKEY_{DEST}:

### ITPA_{DEST}:

| | | |
|---|---|---|
| 39...36 | 35 ... 24 | 23 ... 0 |
| 1 0 0 0 | VIKEY_{DEST} | IOVA_{DEST} |

A second translation, carried out on the hypervisor which executes this virtual machine, makes it possible to translate the intermediate temporary physical address ITPA_{DEST} into the temporary physical address TPA_{DEST}.

In this case also, the step 216 is adapted to recover the physical address PA_{DEST} in two successive translations carried out by the IOMMU 52. A first translation, carried out on the virtual machine that executes the second software process in the second circuit 34, makes it possible to translate the transport address TA_{DEST} into an Intermediate physical address IPA_{DEST} over 40 bits. A second translation, carried out on the hypervisor which executes this virtual machine, makes it possible to translate the intermediate physical address IPA_{DEST} into the physical address PA_{DEST} coded over 40 bits.

In this case also, note that the manager of the first access port of the first circuit 12 is the hypervisor of the main processor 14.

As with the third embodiment, the first and second embodiments could also be adapted to executions of their software processes on virtual machines by adapting their steps in accordance with what was done for the fourth embodiment.

It clearly appears that a method for executing a request to exchange data such as one of those described hereinabove makes it possible, via cunning executed in the steps 112 and 212 described hereinabove, reading or writing of data remotely, i.e. from a circuit on a card or chip to the other in a system of interconnected circuits, without invoking the processor of the remote circuit and without any need for network adaptation.

Furthermore, it is advantageous to be able to take advantage of the memory management units that are dedicated to input/output and virtualization technologies in order to implement a method according to the invention.

Furthermore, in the embodiments described in reference to FIGS. 3A and 3B, it is advantageous to be able to use the RDMA programming model and consequently to benefit from the corresponding software libraries and from the OFED™ (“OpenFabrics Enterprise Distribution”) programming interface on low-consumption circuits that do not comprise controllers in accordance with the Infiniband or RoCE protocol.

Note moreover that the invention is not limited to the embodiments described hereinabove. It will indeed appear to those skilled in the art that various modifications can be made to the embodiments described hereinabove, in light of the teaching that has just been disclosed to them. In the claims that follow, the terms used must not be interpreted as limiting the claims to the embodiments exposed in this description, but must be interpreted in order to include therein all of the equivalents that the claims aim to cover due to their formulation and of which the foresight is within the scope of those skilled in the art by applying their general knowledge to the implementation of the teaching that has just been disclosed to them.

1: A method for executing a request to exchange data between first and second disjoint physical addressing spaces respectively controlled by first and second separate chip or card circuits, comprising the following steps:
creation of a communication channel between:
a first access port of the first circuit, obtained by a first software process that executes in the first circuit that comprises at least one processor for executing this first software process in the first physical addressing space, and
a second access port of the second circuit, obtained by a second software process that executes in the second circuit that comprises at least one processor for executing this second software process in the second physical addressing space,
sending, by the first software process, of said request to exchange data, wherein this request designates a virtual address in a virtual addressing space of the second software process, and
executing, by managers of the first and second access ports, of the request to exchange data between the disjoint physical addressing spaces of the two software processes, without invoking the processor executing the second software process,
characterized in that:
during the creation of the communication channel, a translation of the virtual addressing space of the second software process into its physical addressing space is created and associated to this communication channel in the second circuit, and
during the execution of the request, data for identification of the communication channel is added to the virtual address designated in the request by adding a few bits to the virtual address designated in the request in order to insert this data therein for identification of the communication channel.

2: The method for executing a request to exchange data as claimed in claim 1, wherein the translation of the virtual addressing space of the second software process into its physical addressing space is used by a memory management unit of the second circuit in order to determine which physical address of the second physical addressing space corresponds to the virtual address designated in the request using the data for identification of the communication channel added to this virtual address.

3: The method for executing a request to exchange data as claimed in claim 1, wherein the data for identification of the communication channel added to the virtual address designated in the request comprises an identifier of the second circuit, of an operating system whereon the second software process is executed and of the second access port obtained by the second software process, and an identifier of an exchange buffer memory defined on the side of the second circuit.

4: The method for executing a request to exchange data as claimed in claim 1, wherein the data for identification of the communication channel is added to the virtual address designated in the request by the manager of the first access port of the first circuit.

5: The method for executing a request to exchange data as claimed in claim 1, wherein the adding of data for identification of the communication channel to the virtual address designated in the request is carried out through encapsulation of this virtual address with this data for identification of the communication channel in a transport address, with this transport address being sent then processed by the manager of the second access port as a virtual address to be translated.

6: The method for executing a request to exchange data as claimed in claim 1, wherein the execution of the request is managed by direct communication established between the processor of the first circuit and a local memory of the second circuit.

7: The method for executing a request to exchange data according to claim 6, wherein:
the translation of the virtual addressing space of the first software process into its physical addressing space is used by a memory management unit of the processor of the first circuit, and
this memory management unit further makes use of the translation of the virtual addressing space of the second software process into a temporary physical addressing space used to index a look-up table wherein the data for identification of the communication channel is stored.

8: The method for executing a request to exchange data as claimed in claim 1, wherein the execution of the request is managed by an indirect communication established between the processor of the first circuit and a local memory of the second circuit with the invoking of a direct memory access controller for read and write access, in local memory or remotely, independent of the processor of the first circuit.

9: The method for executing a request to exchange data as claimed in claim 8, wherein:
The translation of the virtual addressing space of the first software process into its physical addressing space is used by a memory management unit associated specifically with the direct memory access controller, and
this memory management unit further makes use of the translation of the virtual addressing space of the second software process into a temporary physical addressing space used to index a look-up table wherein the data for identification of the communication channel is stored.

10: The method for executing a request to exchange data as claimed in claim 1, wherein the request to exchange data sent by the first software process concerns:
a reading of the data stored in the first physical addressing space wherein the first software process is executed and a writing of this data in the second physical addressing space wherein the second software process is executed, or
a reading of the data stored in the second physical addressing space wherein the second software process is executed and a writing of this data in the first physical addressing space wherein the first software process is executed.

11: The method for executing a request to exchange data as claimed in claim 1, wherein at least one of the first and second software processes is executed on a virtual machine which is itself executed by a hypervisor of the corresponding processor, with each translation of a virtual address into a corresponding local physical address comprising a translation of the virtual address into an intermediate physical address as viewed by the virtual machine and a translation of the intermediate physical address into a physical address as seen by the hypervisor.
